(19) United States
(12) Patent Application Publication
(10) Pub. No.: US 2012/0168632 A1
(43) Pub. Date: Jul. 5, 2012

(54) ELECTRONIC CASSETTE FOR RADIATION IMAGING

(75) Inventors: Keita YAGI, Ashigarakami-gun (JP); Yusuke KITAGAWA, Ashigarakami-gun (JP); Katsumi SHIMADA, Ashigarakami-gun (JP)

(73) Assignee: FUJIFILM CORPORATION, Tokyo (JP)

(21) Appl. No.: 13/341,243

(22) Filed: Dec. 30, 2011

(30) Foreign Application Priority Data
Jan. 5, 2011 (JP) 2011-000609

(51) Int. Cl. G01T 1/20

(52) U.S. Cl. 250/366

(57) ABSTRACT

An electronic cassette for radiation imaging has an image detection device for forming an image of an object irradiated with radiation. The image detection device includes a housing. A window opening is formed in the housing, for receiving the radiation. A scintillator is contained in the housing, for converting the radiation from the window opening into light. A detection panel is contained in the housing, disposed between the scintillator and window opening, for converting the light into a signal. A radio transparent plate of a quadrilateral shape is disposed to close the window opening, is radio transparent to the radiation, has at least high and low thermal conductivity sheets arranged in a direction of entry of the radiation into the housing, the radio transparent plate being so anisotropic that thermal conductivity is higher in a longitudinal direction of the quadrilateral shape than in a transverse direction of the quadrilateral shape.

### BACKGROUND OF THE INVENTION

1. Field of the Invention

The present invention relates to an electronic cassette for radiation imaging. More particularly, the present invention relates to an electronic cassette for radiation imaging, in which unevenness in temperature can be prevented to keep image quality of a radiation image.

2. Description Related to the Prior Art

An X-ray imaging system as radiation imaging system is known in the field of medical diagnosis by use of X-rays as radiation. An X-ray imaging apparatus included in the X-ray imaging system forms an X-ray image of an object by receiving the X-rays transmitted through the object after irradiation with an X-ray source. Specifically, an image detection device or FPD device (flat panel detection device) is incorporated in the X-ray imaging apparatus. A detection surface of the image detection device has pixels for storing signal charge according to an amount of received X-rays. An X-ray image is formed by storing the signal charge for each of the pixels, by way of image information of the object. Image data of a digital form is output according to the image information.

A well-known type of the image detection device is an indirect conversion type, which includes a detection panel and a scintillator. The detection panel has an insulating substrate of glass and a photoelectric conversion layer formed on the substrate by pixels for generating charge photoelectrically as the detection surface. The scintillator is disposed on the detection surface of the detection panel and converts X-rays into visible light. In operation, the scintillator receives the X-rays and generates visible light. The detection panel converts the visible light into signal charge.

Plural types of the X-ray imaging apparatuses are well-known, including a fixed type (installation type) and a portable type. The fixed type has the image detection device and a floor stand or X-ray table where a patient is positioned for imaging his or her body part. The portable type is an electronic cassette or detector module (sensor module), which includes a housing of a horizontally extending form and the image detection device incorporated in the housing. The use of the electronic cassette is similar to that of an X-ray film cassette and imaging plate cassette (IP cassette) as a conventionally used article with photosensitive materials. The electronic cassette can be carried to reach a bed of a patient who cannot easily move to an examination room for imaging, and can be utilized for imaging of a small body part difficult to image with a fixed type, for example, hands, legs, elbows, knees, other joints and the like.

Among various sizes standardized for the electronic cassette, the housing of the electronic cassette have a size of 383.5×459.5 mm, which is widely used as a size of the X-ray film cassette and imaging plate cassette. This is advantageous in that the electronic cassette can be used even in a conventional floor stand or X-ray table constructed for the X-ray film cassette and imaging plate cassette.

For reliability of the housing of the electronic cassette, there are requirements for a preferable structure of the housing. First, the housing should be lightweight for portability. Secondly, a front cover included in the housing should have a high radio transparency, because of transmission of X-rays to enter the housing. Thirdly, a receiving surface of the housing should have a sufficient rigidity resistant to weight of an object or body part, typically when the electronic cassette is used at a bed or table separately from the floor stand or X-ray table of the X-ray imaging apparatus.

JP-A 2005-313613 and U.S. Pat. No. 4,638,501 (corresponding to JP-Y 2-048841) disclose an example of a radio transparent plate for the housing of the electronic cassette, the radio transparent plate formed from carbon material having a lightweight property, high rigidity and have high radio transparency. In JP-A 2005-313613, the radio transparent plate is in a sandwich form including a core layer and two layers for sandwiching the core layer. Either one of the core layer and the two layers is formed from CFRP (carbon fiber reinforced plastic). A remaining one of the core layer and the first and second layers is formed from AFRP (aramid fiber reinforced plastic) containing aromatic polyamide fiber. This is effective in keeping high rigidity and preventing occurrence of surface breakage of the radio transparent plate by covering the CFRP with the AFRP. U.S. Pat. No. 4,638,501 discloses the radio transparent plate having a core layer and two layers for sandwiching the core layer. The core layer is formed from resin. The two layers are formed from the CFRP, so it is possible to keeping high rigidity and high radio transparency.

The detection panel of the image detection device reacts to a change in the temperature more remarkably than the X-ray film cassette and imaging plate cassette. Occurrence of temperature unevenness on the detection surface of the detection panel may easily causes density unevenness in an image formed by the image detection device. As the detection surface of the detection panel is in a position different from that of the radio transparent plate of the housing on a plane of projection, the temperature unevenness is created on the radio transparent plate by local rise of the temperature to influence the temperature unevenness of the detection panel.

When the electronic cassette is used separately for imaging of the object, the object directly contacts the radio transparent plate, of which a contact portion is warmed by the body temperature of the object. If a size of the object is smaller than a size of the radio transparent plate, for example, for imaging of hands or legs, the temperature unevenness is likely to occur on the radio transparent plate because the contact portion is present in the radio transparent plate. In the electronic cassette, the housing is a type of a small thickness in contrast with the fixed type of the X-ray imaging apparatus. There is a problem in unwanted conduction of residual heat of the radio transparent plate to the detection panel due to the closeness of the radio transparent plate to the detection panel.

An ISS method or irradiation side sampling method is known in the image detection device, in which its elements are arranged in an order of the detection panel and the scintillator in the housing from the outer side of X-rays toward the inner side. Namely, the detection surface of the detection panel is opposed to a receiving surface of the scintillator for X-rays. The problem of the temperature unevenness is specifically serious in the ISS method. The detection panel is disposed much closer to the radio transparent plate according to the ISS method than according to a PSS method or penetration side sampling method, in which elements are arranged in an order of the radio transparent plate, the scintillator and the detection panel.

JP-A 2005-313613 and U.S. Pat. No. 4,638,501 disclose the radio transparent plate with a lightweight property, high rigidity and high radio transparency, but do not suggest prevention of the temperature unevenness of the detection panel due to residual heat given through the radio transparent plate.

### SUMMARY OF THE INVENTION

In view of the foregoing problems, an object of the present invention is to provide an electronic cassette for radiation imaging, in which unevenness in temperature can be prevented to keep image quality of a radiation image.

In order to achieve the above and other objects and advantages of this invention, an electronic cassette for detecting radiation from an object to form an image thereof according to radiation imaging is provided. There is a radio transparent plate of a quadrilateral shape, including at least high and low thermal conductivity sheets superimposed on one another in a direction of entry of the radiation, and being so anisotropic that thermal conductivity is higher in a longitudinal direction of the quadrilateral shape than in a transverse direction of the quadrilateral shape. A scintillator converts the radiation passed through the radio transparent plate into light. A detection panel converts the light from the scintillator into an electric signal. A housing contains the scintillator and the detection panel, the housing having one receiving surface where the radio transparent plate is disposed.

The high thermal conductivity sheet is disposed at an outer surface of the radio transparent plate.

Furthermore, an opening is formed in the receiving surface of the housing, and closed by the radio transparent plate secured thereto.

The high thermal conductivity sheet contains carbon material.

The high thermal conductivity sheet includes at least one first prepreg layer, produced by impregnating matrix resin in carbon fibers, and disposed to align the carbon fibers in the longitudinal direction. At least one second prepreg layer is produced by impregnating matrix resin in carbon fibers, and disposed to align the carbon fibers in the transverse direction.

A layer number of the at least one first prepreg layer is higher than a layer number of the at least one second prepreg layer.

The second prepreg layer is superimposed on the first prepreg layer in an alternate manner therewith.

The second prepreg layer is disposed at each one of points between a plurality of the first prepreg layer.

In one preferred embodiment, a plurality of the first prepreg layer include two or more layers superimposed directly on one another.

The detection panel is secured to an inner surface of the radio transparent plate inside the housing.

The detection panel is attached by adhesion.

A condition

TL/TS=L/S

is satisfied, where TL is the thermal conductivity of the high thermal conductivity sheet in the longitudinal direction, TS is the thermal conductivity of the high thermal conductivity sheet in the transverse direction, L is a length of a longer side line of the quadrilateral shape, and S is a length of a shorter side line of the quadrilateral shape.

The housing has a size according to international standard ISO 4090:2001.

In one preferred embodiment, an electronic cassette for radiation imaging is provided, having an image detection device for forming an image of an object irradiated with radiation. The image detection device includes a housing. A window opening is formed in the housing, for receiving the radiation. A scintillator is contained in the housing, for converting the radiation from the window opening into light. A detection panel is contained in the housing, disposed between the scintillator and the window opening, for converting the light into a signal. A radio transparent plate of a substantially quadrilateral shape is disposed to close the window opening, is radio transparent to the radiation, has at least high and low thermal conductivity sheets arranged in a direction of entry of the radiation into the housing, the radio transparent plate being so anisotropic that thermal conductivity is higher in a longitudinal direction of the quadrilateral shape than in a transverse direction of the quadrilateral shape.

The high thermal conductivity sheet is disposed at an outer surface of the housing.

Accordingly, unevenness in temperature can be prevented to keep image quality of a radiation image, because the radio transparent plate is anisotropic in relation to the thermal conductivity.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating an X-ray imaging system;

FIG. 2 is a perspective view illustrating an electronic cassette;

FIG. 3 is a block diagram illustrating an image detection device (FPD);

FIG. 4 is an exploded perspective view illustrating the electronic cassette;

FIG. 5 is a cross section illustrating the electronic cassette;

FIG. 6 is an explanatory view in section illustrating a radio transparent plate;

FIG. 7 is an explanatory view in perspective illustrating a high thermal conductivity sheet;

FIG. 8 is an explanatory view in plan illustrating the high thermal conductivity sheet with anisotropy in the thermal conductivity;

FIG. 9 is an explanatory view in perspective illustrating another preferred example of high thermal conductivity sheet.

### DETAILED DESCRIPTION OF THE PREFERRED

### Embodiment(s) of the Present Invention

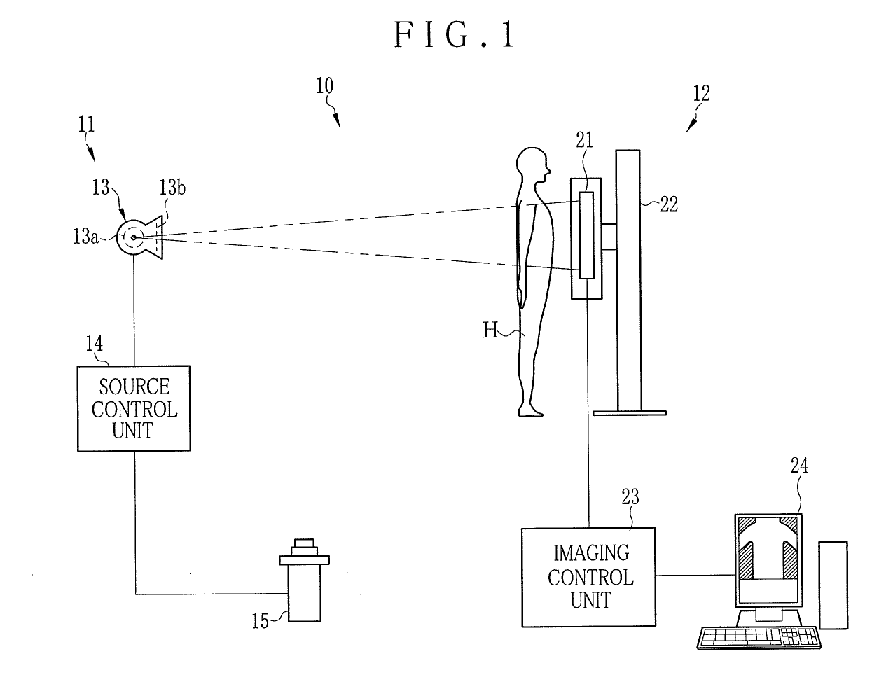

In FIG. 1, an X-ray imaging system 10 as radiation imaging system includes an X-ray source apparatus 11 and an X-ray imaging apparatus 12. The X-ray source apparatus 11 includes an X-ray source 13, a source control unit 14 and a start switch 15. The source control unit 14 controls the X-ray source 13. The X-ray source 13 includes an X-ray tube 13a and a collimator 13b for limiting an area of X-rays from the X-ray tube 13a. The X-ray tube 13a has positive and negative electrodes.

The negative electrode has filaments for emitting thermal electron. The positive electrode is a target for emitting X-rays by impinging on the thermal electron from the negative electrode. An example of the collimator 13b has a collimator opening and a plurality of lead plates. The collimator opening is disposed at the center. The lead plates are combined in a grating form for shielding X-rays, and are moved to change an opening size of the collimator opening to determine an area of view.

The source control unit 14 includes a voltage source and a controller. The voltage source applies high voltage to the X-ray source 13. The controller controls tube voltage, tube current and irradiation time, the tube voltage determining energy spectrum of X-rays emitted by the X-ray source 13, the tube current determining dose of X-rays per unit time, the irradiation time being time of continuation of X-ray emission. The voltage source has a transformer for boosting an input voltage to obtain tube voltage of the high level, and supplies power to the X-ray source 13 through the cable. The tube voltage, tube current and irradiation time as imaging conditions are determined manually by an operator manipulating an input panel of the source control unit 14, or can be determined electrically through a communication cable from the X-ray imaging apparatus 12.

The start switch 15 is an input unit for inputting a control signal to the source control unit 14. The start switch 15 is a two stage switch (two stage button), and when depressed halfway, inputs a start signal for warmup of the X-ray source 13, and when depressed fully, inputs an emission signal for starting the X-ray source 13 to emit X-rays.

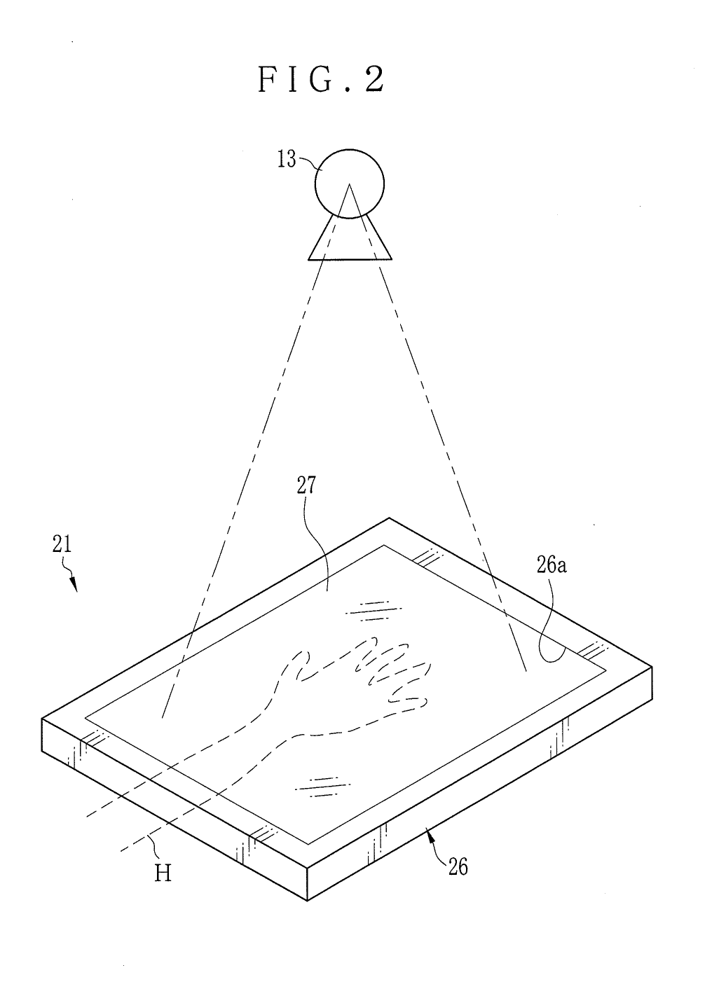

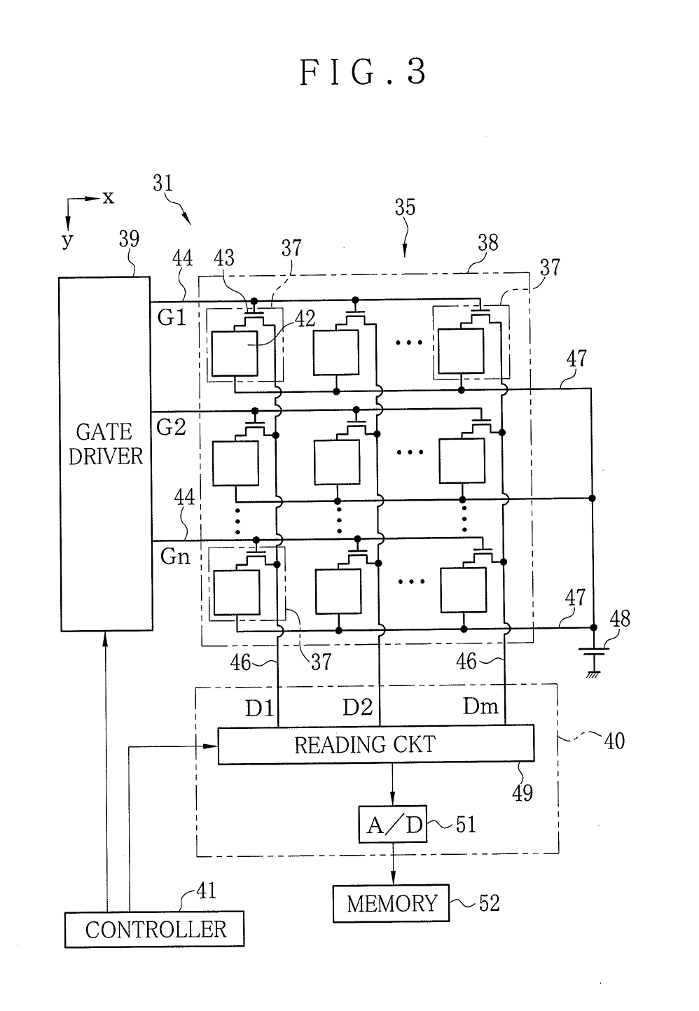

The X-ray imaging apparatus 12 includes an electronic cassette 21 or detector module (sensor module), a floor stand 22 for imaging, an imaging control unit 23, and a console unit 24. The electronic cassette 21 includes an image detection device 31 or FPD device (flat panel detection device) (FIG. 3), and a portable housing 26 (FIG. 2) for containing the image detection device 31. X-rays, emitted by the X-ray source 13 and transmitted through the patient or object H, are detected by the electronic cassette 21 to form an X-ray image. The housing 26 of the electronic cassette 21 has a horizontally extending form of a box. The housing 26 has a size according to the international standard ISO 4090:2001 in the same manner as the film or IP cassette of a standardized size 383.5×459.5 mm. In FIG. 2, a window opening 26a constituting a receiving surface is formed in the housing 26. A profile form of the housing 26 is a rectangular quadrilateral.

The floor stand 22 has a slot for receiving entry of the electronic cassette 21 in a removable manner, and holds the electronic cassette 21 in an orientation to oppose its incident surface to the X-ray source 13. As the housing 26 of the electronic cassette 21 has a size substantially similar to that of the film cassette or IP cassette, the electronic cassette 21 can be set on a floor stand for the film cassette or IP cassette. Note that the patient as object H, although in an erect orientation according to the floor stand 22 of the embodiment, can be imaged in a horizontally lying orientation. To this end, an X-ray table for placement of the patient is used instead of the floor stand 22.

The imaging control unit 23 is connected with the electronic cassette 21 according to a wired or wireless communication system, and controls the electronic cassette 21. Specifically, the imaging control unit 23 sends information of an imaging condition to the electronic cassette 21 for determining a processing condition of signal processing of the image detection device 31, for example, input gain of an integration amplifier for amplifying voltage according to signal charge. The imaging control unit 23 receives a sync signal from the X-ray source apparatus 11 for synchronizing the emission from the X-ray source 13 with the storage of the image detection device 31. The imaging control unit 23 sends the sync signal to the X-ray imaging apparatus 12 to control the X-ray source 13 and the image detection device 31 in a synchronized manner. Also, the imaging control unit 23 receives the image data output by the electronic cassette 21, and sends the image data to the console unit 24.

The console unit 24 receives inputs of personal information of the patient in relation to a diagnosis case, such as sex, age, body part, hospital department, purpose and the like, and displays the information of the diagnosis case. The diagnosis case information is originally supplied by an outer system for managing patient information or diagnosis information, such as the HIS (Hospital Information System) and RIS (Radiography Information System). Also, the diagnosis case information can be input originally by an operator or technician manually. He or she observes the diagnosis case information on a display panel, and selectively determines an imaging condition by viewing images on the console unit 24. The condition information is sent to the imaging control unit 23.

The console unit 24 processes the data of X-ray images transmitted from the imaging control unit 23 for image processing. The processed X-ray images are displayed on a display panel of the console unit 24. Data of those are stored in a storage medium, for example, a hard disk device or memory in the console unit 24, and an image server connected with the console unit 24 by a network.

In FIG. 2, a doctor wishes to image a hand, foot and the like of the patient as object H, which are difficult to place on the electronic cassette 21 positioned on the floor stand 22. To this end, the electronic cassette 21 is removed from the floor stand 22 for use. To image the hand, the electronic cassette 21 is placed on a table, bed or the like by directing the window opening 26a upwards as a part of the housing 26. The hand of the patient as object H is placed at the center of the window opening 26a for imaging. A radio transparent plate 27 as X-ray transparent plate constitutes a receiving surface, and fitted in the window opening 26a. If the electronic cassette 21 is removed from the floor stand 22 for imaging, a body part of the patient as object H is kept in direct contact with the radio transparent plate 27 for imaging.

In FIG. 3, the image detection device 31 includes a detection panel 35, a gate driver 39, a signal processor 40 and a controller 41. The detection panel 35 includes a detection surface 38 and plural pixels 37. The pixels 37 are arranged on the detection surface 38 and in plural arrays, and store charge according to an incident radiation amount of X-rays. The gate driver 39 drives the pixels 37 and controls reading of the signal charge. The signal processor 40 converts the signal charge from the pixels 37 into digital data. The controller 41 controls the gate driver 39 and the signal processor 40 for controlling the image detection device 31. The pixels 37 are arranged in plural arrays of G1-Gn in the x direction and of D1-Dm in the y direction at predetermined pitches.

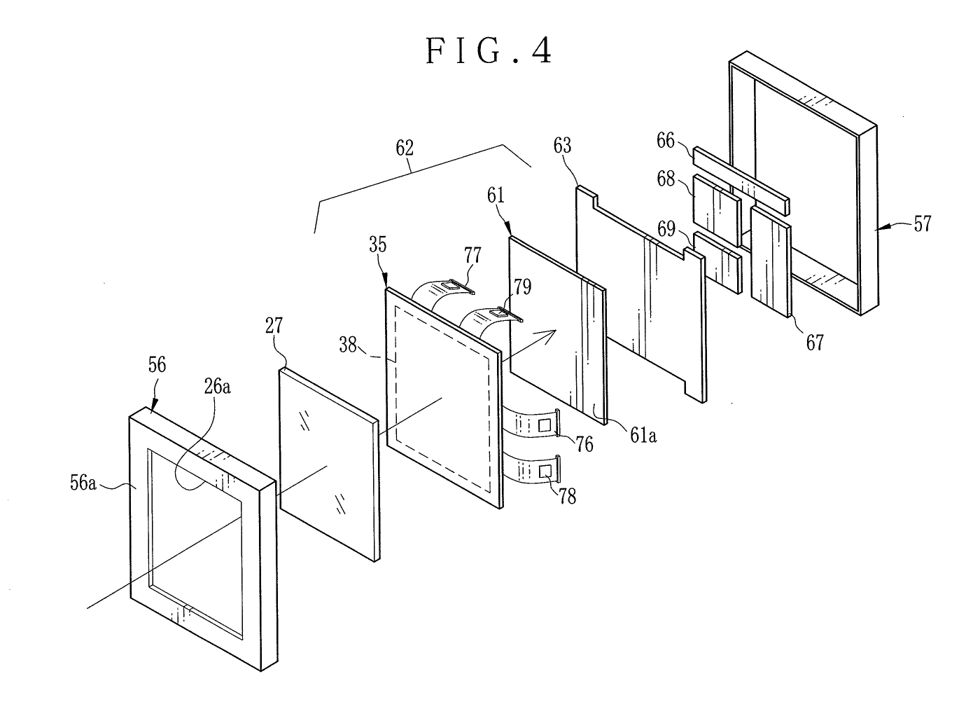

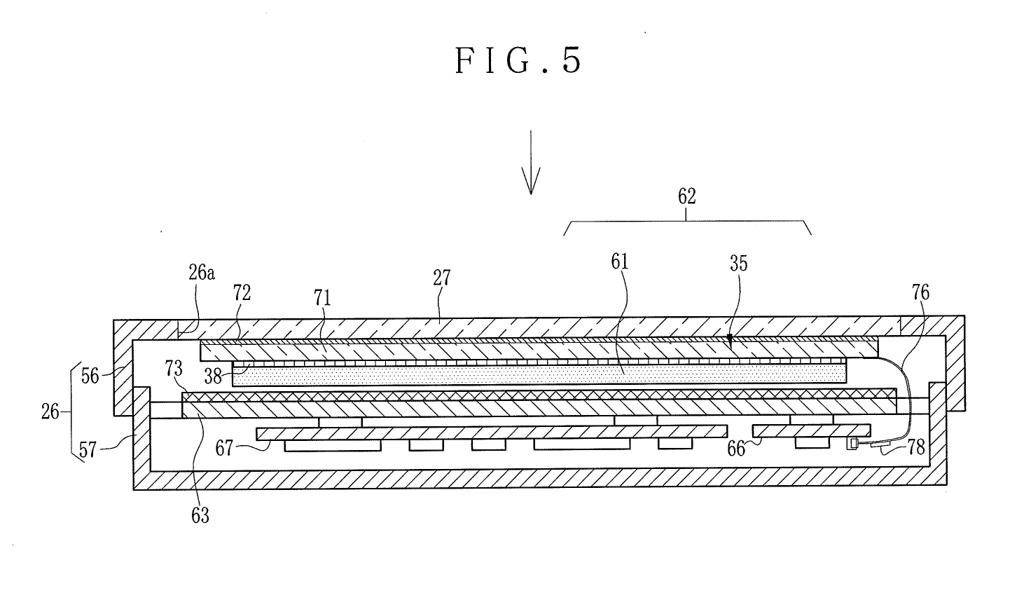

The image detection device 31 is an indirect conversion type in which X-rays are converted into visible light, and the visible light is converted photoelectrically to store signal charge. The detection panel 35 is a photoelectric conversion panel, in which the pixels 37 convert the visible light photoelectrically. A scintillator 61 for converting X-rays into visible light is disposed on the detection surface 38, and opposed to the whole of the detection surface 38. See FIGS. 4 and 5. The scintillator 61 includes phosphor, such as cesium iodide (CsI) and gadolinium oxysulfide (GOS). An example of the scintillator 61 has a support, the phosphor, and a sheet coated with phosphor and attached to the support with adhesive agent. Also, the scintillator 61 is constituted by the phosphor overlaid on the detection surface 38 by use of vapor deposition.

The detection surface 38 has a form of the standardized size 383.5×459.5 mm. The radio transparent plate 27 has a quadrilateral form according to the size of the detection surface 38.

Each of the pixels 37 includes a photo diode 42 and a capacitor. The photo diode 42 is a photoelectric conversion device for generating charge (electrons and positive holes) upon receiving visible light. The capacitor stores the charge generated by the photo diode 42. A thin film transistor 43 (TFT) is a switching element associated with the pixels 37. The detection panel 35 is a TFT active matrix substrate, which includes a glass substrate 71 of insulation and the pixels 37 formed on the glass substrate 71. See FIG. 5.

The photo diode 42 has a structure including a semiconductor layer of amorphous silicon (a-Si), for example PIN type, and upper and lower electrodes formed on the semiconductor layer. The thin film transistor 43 is connected to the lower electrode of the photo diode 42. A bias line 47 is connected to the upper electrode. A bias power source 48 applies bias voltage to the photo diode 42. An electric field is created in the semiconductor layer by applying the bias voltage. Charge (electrons and positive holes) created in the semiconductor layer by the photoelectric conversion moves to the upper and lower electrodes having positive and negative polarities, so that a capacitor stores the charge.

The thin film transistor 43 has a gate electrode, a source electrode and a drain electrode. A scan line 44 is connected to the gate electrode. A signal line 46 is connected to the source electrode. The drain electrode is connected with the photo diode 42. The scan line 44 and the signal line 46 are arranged in a grating form. The scan line 44 includes horizontal line elements of the number n of the pixels 37 of the detection surface 38. The signal line 46 includes vertical line elements of the number m of the pixels 37. The scan line 44 is connected with the gate driver 39. A reading circuit 49 is connected with the signal line 46.

The reading circuit 49 includes an integration amplifier and a multiplexer. The integration amplifier converts signal charge read from the detection panel 35 into a voltage signal. The multiplexer changes over arrays of the pixels 37 on the detection surface 38 to output the voltage signal array after array. An A/D converter 51 converts the voltage signal from the reading circuit 49 into digital data. A memory 52 is accessed to store the digital data or image data.

In FIGS. 4 and 5, the housing 26 includes a front cover 56 and a rear cover 57. A panel unit 62 includes the detection panel 35 and the scintillator 61. The front and rear covers 56 and 57 cover the panel unit 62. The front cover 56 has the window opening 26a. The front cover 56 includes a cover frame 56a and the radio transparent plate 27. The window opening 26a is defined in the cover frame 56a. The radio transparent plate 27 is fitted in the window opening 26a. The radio transparent plate 27 is formed from carbon material having a lightweight property, high rigidity, and high X-ray transparency. A material of the cover frame 56a is resin. A material of the rear cover 57 is stainless steel or other metal. There are plural elements disposed behind the panel unit 62, including a base plate 63 and circuit boards 66, 67, 68 and 69.

The electronic cassette 21 is structured according to an ISS method (irradiation side sampling method). An X-ray receiving surface 61a of the scintillator 61 is opposed to the detection surface 38 of the detection panel 35. In the panel unit 62, the detection panel 35 and the scintillator 61 are arranged from a side of the window opening 26a of the housing 26.

X-rays attenuate according to entry in the thickness direction of the scintillator 61. Also, visible light emitted by the scintillator 61 attenuates within the same. A light amount of the light from the scintillator 61 is the highest on the receiving surface 61a where X-rays become incident. Note that efficiency in light detection is better in the ISS method (irradiation side sampling method) than in the PSS method (penetration side sampling method), because the light on the receiving surface 61a of the scintillator 61 is detected by the detection surface 38 of the detection panel 35. The ISS method is also called a method of back side irradiation, because X-rays enter the back surface of the detection panel 35 reverse to the detection surface 38.

According to the ISS method, the back surface of the detection panel 35 is opposed to the inner surface of the radio transparent plate 27. To reduce the thickness of the housing 26, the glass substrate 71 is attached to the inner surface of the radio transparent plate 27 with a double-sided adhesive tape 72 (double-sided pressure sensitive adhesive tape), adhesive agent or the like, in order to hold the panel unit 62. The circuit boards 66-69 are attached to the base plate 63. An example of material of the base plate 63 is stainless steel. A plate of copper is attached to a front surface of the base plate 63 to block X-rays directed to the circuit boards 66-69. A thermal insulator 73 is disposed between the base plate 63 and the scintillator 61 and behind the receiving surface 61a of the scintillator 61, and prevents conduction of heat from the circuit boards 66-69 to the detection panel 35. An example of the thermal insulator 73 is a sheet of sponge or other porous material.

The circuit board 66 has circuit elements of the gate driver 39 for driving the TFT of the detection panel 35. The circuit board 67 has circuit elements of the A/D converter 51. The circuit board 68 has circuit elements of the controller 41. The circuit board 69 has circuit elements of a power source circuit, such as AC/DC converter, DC/DC converter and the like.

There are flexible cables 76 and 77 for connecting respectively the circuit boards 66 and 67 to the detection panel 35. IC chips 78 and 79 of the TCP type (tape carrier package) are mounted on respectively the flexible cables 76 and 77. The IC chip 78 includes a shift register for shifting a gate pulse serially by a unit of lines of the pixels 37, and constitutes the gate driver 39 in combination with circuit elements on the circuit board 66. The IC chip 79 is an ASIC (application specific IC) for constituting the reading circuit 49.

There is no scintillator between the detection panel 35 and the radio transparent plate 27 according to the ISS method in contrast with the PSS method. In comparison with the PSS method, the radio transparent plate 27 is disposed nearer to the detection panel 35, so that residual heat of the radio transparent plate 27 is easily transmitted to the detection panel 35. As the radio transparent plate 27 overlaps on the detection surface 38 of the detection panel 35 in the plane of the projection, residual heat of the radio transparent plate 27 conducts to the detection panel if unevenness in the temperature occurs in the radio transparent plate 27. There is temperature dependence of sensitivity and a characteristic of dark current of the photo diode 42. Occurrence of temperature unevenness on the detection surface 38 causes density unevenness in an image.

In FIG. 2, a hand of a patient or object H contacts the radio transparent plate 27 during operation of imaging. It is likely that heat is developed by a palm or fingers of the patient, locally to raise the temperature of the radio transparent plate 27.

Unevenness in the density of an image occurs to cause unwanted imaging of the palm or fingers.

Carbon material is used for the radio transparent plate 27 with advantages of the lightweight property, high rigidity, and high X-ray transparency. Basic conditions of the radio transparent plate 27 are satisfied by the carbon material. Also, temperature unevenness is suppressed sufficiently on the detection surface 38 of the detection panel 35 even upon local rise in the temperature on the plane of the radio transparent plate 27, which will be described below.

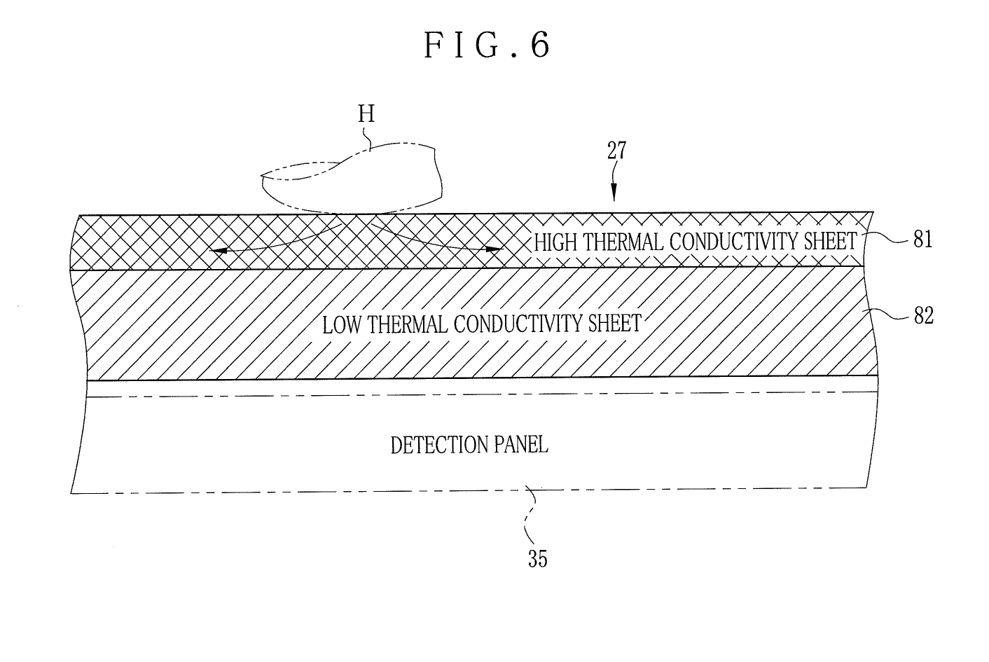

In FIG. 6, the radio transparent plate 27 has a high thermal conductivity sheet 81 and a low thermal conductivity sheet 82 as layers disposed in an inward order from the window opening 26a of the housing 26. There is a difference in a thermal conductivity between the high and low thermal conductivity sheets 81 and 82.

The high thermal conductivity sheet 81 is disposed on an outer side, and appears externally. The low thermal conductivity sheet 82 is disposed on an inner side in the housing 26 and near to the detection panel 35.

The high thermal conductivity sheet 81 contacts the object H because located externally in the radio transparent plate 27. Heat of the object H is transmitted to a contacted portion of the high thermal conductivity sheet 81. Then the heat is transmitted to wide portions around the contacted portion. A speed of transmitting the heat is higher in the high thermal conductivity sheet 81 than in the low thermal conductivity sheet 82.

Accordingly, the heat generated from the contact portions is scattered within the high thermal conductivity sheet 81 before transmission to the low thermal conductivity sheet 82. See the arrow in FIG. 6. In comparison with a conventional radio transparent plate with layers of an equal thermal conductivity, the low thermal conductivity sheet 82 disposed internally operates as thermal insulator. Heat does not conduct toward the detection panel 35 or internally in the thickness direction 27, but is easy to scatter on a plane being perpendicular to the thickness direction. It is possible to prevent occurrence of unevenness in the temperature upon locally warming the radio transparent plate 27 if the patient or object contacts a portion of the radio transparent plate 27. The unevenness in the temperature of the detection surface 38 of the detection panel 35 can be suppressed sufficiently even with residual heat of the radio transparent plate 27, to prevent occurrence in the unevenness in the density of an image.

The high thermal conductivity sheet 81, as disposed on the outermost side, is exposed to the atmosphere. Heat at the inner surface of the high thermal conductivity sheet 81 is dissipated to the atmosphere. This is effective in high heat dissipation and preventing storage of heat in the radio transparent plate 27.

Materials of the high and low thermal conductivity sheets 81 and 82 are described now. An example of material of the high thermal conductivity sheet 81 is a pitch-based carbon sheet formed from pitch-based carbon material containing pitch-based carbon fibers. An example of material of the low thermal conductivity sheet 82 is a PAN carbon sheet formed from PAN carbon material containing PAN carbon fibers (polyacrylonitryl carbon fibers). The radio transparent plate 27 is obtained by attaching the high and low thermal conductivity sheets 81 and 82 in one of various available methods, for example, hot pressing, welding, adhesion, and the like.

The pitch-based carbon fibers are obtained by carbonizing pitch precursor, which is pitch-based fibers formed from coal tar or heavy petroleum fraction. The PAN carbon fibers are obtained by carbonizing PAN precursor, which is acrylic fibers formed from polyacrylonitryl after polymerizing acrylonitrile. The pitch-based carbon fibers have an advantage of higher thermal conductivity than the PAN carbon fibers. The PAN carbon fibers have an advantage of higher rigidity and lower cost than the pitch-based carbon fibers.

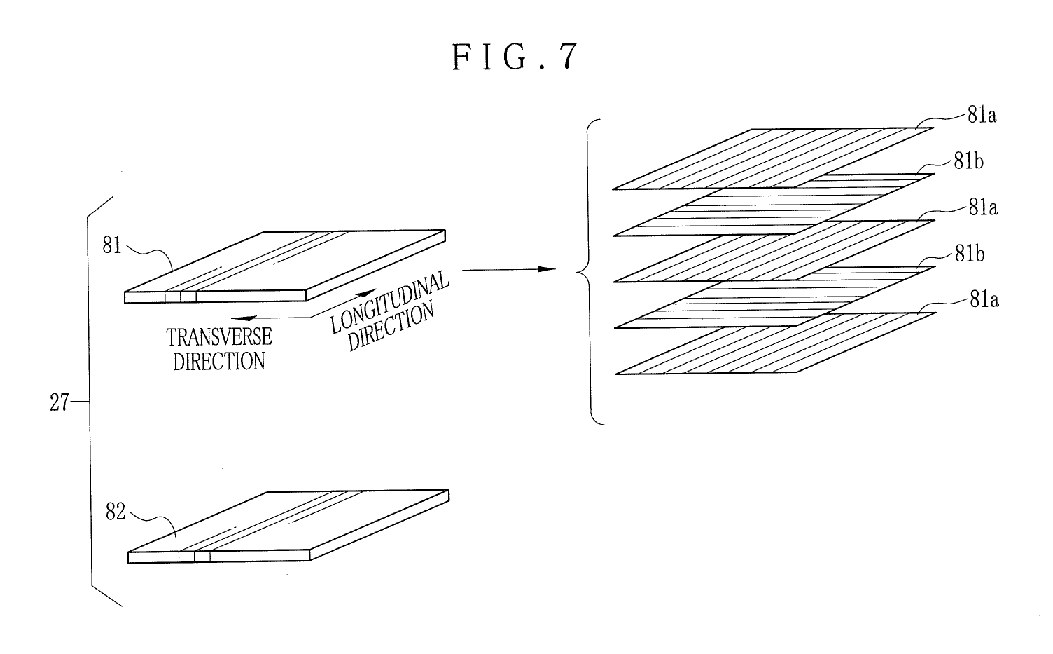

In FIG. 7, the high thermal conductivity sheet 81 is constituted by a plurality of first prepreg layers 81a or prepreg sheet layers and second prepreg layers 81b or prepreg sheet layers stacked together. A fiber direction of carbon fibers of the second prepreg layers 81b is perpendicular to a fiber direction of carbon fibers of the first prepreg layers 81a. Each of the first and second prepreg layers 81a and 81b includes carbon fibers and matrix resin impregnated in the carbon fibers and is shaped in a sheet form. A size of the first and second prepreg layers 81a and 81b is horizontally equal to a size of the radio transparent plate 27. Each of the first and second prepreg layers 81a and 81b is formed by a suitable method, such as a hot pressing, utilized for attaching the low thermal conductivity sheet 82 to the high thermal conductivity sheet 81.

The first prepreg layers 81a are obtained by preparing a carbon fiber sheet in which carbon fibers are aligned together in a longitudinal direction and by impregnating resin in the carbon fiber sheet. The second prepreg layers 81b are obtained by preparing a carbon fiber sheet in which carbon fibers are aligned together in a transverse direction crosswise to the longitudinal direction, and by impregnating resin in the carbon fiber sheet. The carbon fibers have a high thermal conductivity than the resin, so that heat is very likely to conduct in a direction of the carbon fibers. The thermal conductivity is high specially in the fiber direction. In short, the first prepreg layers 81a have a higher thermal conductivity in the longitudinal direction than in the transverse direction. The second prepreg layers 81b have a higher thermal conductivity in the transverse direction than in the longitudinal direction.

The high thermal conductivity sheet 81 is a combination of plural elements among which the first prepreg layers 81a are alternate with the second prepreg layers 81b. This causes intersection of directions of carbon fibers in the first and second prepreg layers 81a and 81b. Heat is transmitted at any of the intersection points. Thus, heat is transmitted in the thickness direction of the high thermal conductivity sheet 81 between the first and second prepreg layers 81a and 81b.

Consequently, heat can be scattered efficiently in both of the longitudinal and transverse directions because the high thermal conductivity sheet 81 is constituted by the first and second prepreg layers 81a and 81b superimposed alternately of which the fiber directions are perpendicular to one another. This is the feature distinct to a known structure in which a direction of fibers in prepreg layers is single.

The number of the first prepreg layers 81a is three, and is higher than two as the number of the second prepreg layers 81b. This is because the first prepreg layers 81a include one disposed the most internally and one disposed the most externally, and the second prepreg layers 81b are disposed between two of the first prepreg layers 81a. The thermal conductivity of the high thermal conductivity sheet 81 in the horizontal direction is anisotropic with a difference between the longitudinal and transverse directions, because the number of the first prepreg layers 81a is higher than that of the second prepreg layers 81b.

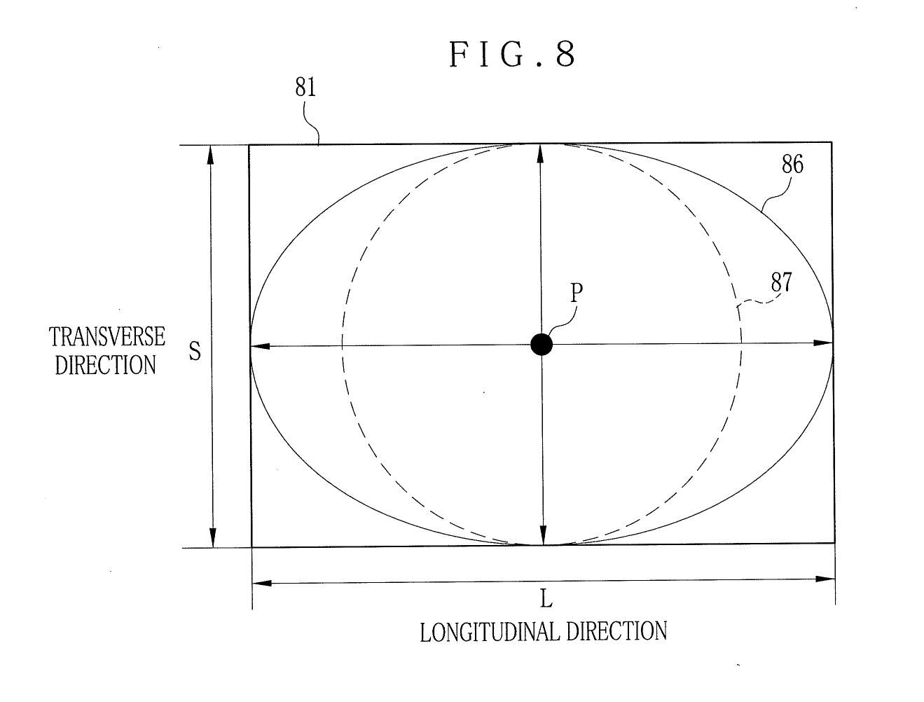

In FIG. 8, the speed of scatter of heat in the horizontal direction is higher in the longitudinal direction than in the transverse direction because the thermal sensitivity is higher in the longitudinal direction. An ellipse 86 of the solid line expresses an area of scattering the heat upon lapse of a predetermined time after the heat is applied to the point P as a center of the high thermal conductivity sheet 81. In contrast, a circle 87 of the broken line expresses an area of scattering the heat in the condition of equal thermal conductivity in the longitudinal and transverse directions. As a horizontal shape of the high thermal conductivity sheet 81 is a rectangular quadrilateral, there is small temperature unevenness owing to high uniformity in the temperature in the form of the ellipse 86 in comparison with the form of the circle 87.

If the thermal conductivity of the two in the transverse direction is equal, an area of scatter of heat per unit time is larger for the ellipse 86 than for the circle 87 because of the higher thermal conductivity in the longitudinal direction. Thus, anisotropy in the thermal conductivity is effective in high heat dissipation specifically when a horizontal shape of the high thermal conductivity sheet 81 is a rectangular quadrilateral.

If a difference in the thermal conductivity between the longitudinal and transverse directions is excessively high, a short axis of the ellipse 86 representing scatter of heat per unit time becomes very short. It is likely that uniformity in the temperature in the horizontal direction and efficiency in the heat dissipation may be lowered, as a region of the high thermal conductivity sheet 81 in its transverse direction cannot be utilized effectively. In the high thermal conductivity sheet 81 of the rectangular quadrilateral shape, an area of scattering heat per unit time is maximized when the following condition is satisfied:

TL/TS=L/S

where TL is the thermal conductivity in the longitudinal direction, TS is the thermal conductivity in the transverse direction, L is a length of a longer side line of the rectangular quadrilateral, and S is a length of a shorter side line of the rectangular quadrilateral. Thus, it is preferable that a difference in the thermal conductivity between the longitudinal and transverse directions in the high thermal conductivity sheet 81 satisfies the above equation.

For a difference in the thermal conductivity between the longitudinal and transverse directions, it is possible to raise the number of the first prepreg layers 81a for higher thermal conductivity in the longitudinal direction, and to raise the number of the second prepreg layers 81b for higher thermal conductivity in the transverse direction. Also, priority may be given to the numbers of the first and second prepreg layers 81a and 81b. For this structure, prepreg layers with a different thermal conductivity can be added to adjust the difference in the thermal conductivity. For example, two types of prepreg layers with different thermal conductivities are used as the first prepreg layers 81a of which the fibers are directed in the longitudinal direction. To raise the thermal conductivity in the longitudinal direction, prepreg layers of a type with a high thermal conductivity are used. To lower the thermal conductivity in the longitudinal direction, prepreg layers of a type with a low thermal conductivity are used.

The low thermal conductivity sheet 82 also constitutes a plurality of prepreg layers in a similar manner to the high thermal conductivity sheet 81. It is possible to form the low thermal conductivity sheet 82 with anisotropic thermal conductivity in a horizontal direction in the similar manner to the high thermal conductivity sheet 81. Heat is transmitted even to the low thermal conductivity sheet 82 with a smaller amount than the high thermal conductivity sheet 81. The anisotropy in the thermal conductivity in the low thermal conductivity sheet 82 is effective in utilizing a rectangular quadrilateral area in the manner of the high thermal conductivity sheet 81.

As described heretofore, if a local rise in the temperature occurs on the plane of the radio transparent plate 27, heat is scattered on the plane of the radio transparent plate 27 so that the temperature becomes uniform. Thus, unevenness in the temperature on the detection surface 38 of the detection panel 35 can be sufficiently suppressed. It is possible to prevent occurrence of unevenness in density of images. The housing 26 has a small thickness. The detection panel 35 is disposed very near to the radio transparent plate 27 typically for the ISS method. From those points of view, the feature of the present invention is specifically important.

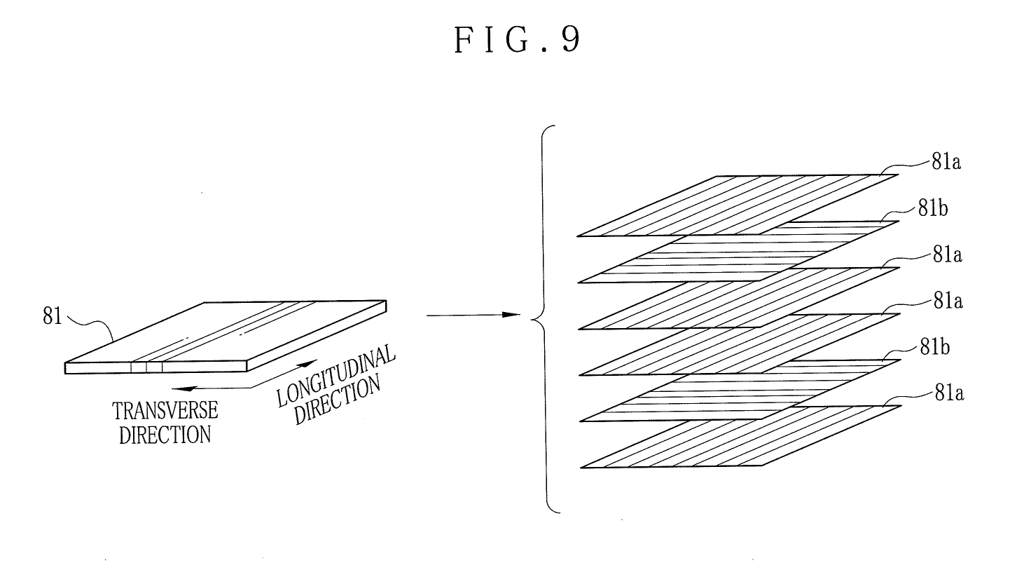

In the above embodiment, the second prepreg layers 81b are arranged alternately with the first prepreg layers 81a. One of the second prepreg layers 81b is disposed at any one of points between the first prepreg layers 81a. In FIG. 9, another preferred example is illustrated, in which two or more of the first prepreg layers 81a are superimposed directly over one another.

In the above embodiment, the high thermal conductivity sheet 81 includes the first and second prepreg layers 81a and 81b. However, only the first prepreg layers 81a can be used in the high thermal conductivity sheet 81 without use of the second prepreg layers 81b. This is effective in the high thermal conductivity sheet 81 in setting a higher thermal conductivity in the longitudinal direction than in the transverse direction. It is preferable to dispose the second prepreg layers 81b in a mixed manner with the first prepreg layers 81a, because an extremely large difference in the thermal conductivity between the longitudinal and transverse directions is unfavorable.

Also, it is possible to use prepreg layers in which resin is impregnated in the transverse fibers (cross fibers) which are obtained by knitting carbon fibers in both of the longitudinal and transverse directions, in addition to the first and second prepreg layers 81a and 81b. Furthermore, prepreg layers of the transverse fibers as a third prepreg layer can be used in addition to the first and second prepreg layers 81a and 81b. Prepreg layers of the transverse fibers can be used in place of the second prepreg layers 81b.

In the above embodiment, one of the first prepreg layers 81a is disposed on the uppermost side. However, the first prepreg layers 81a on an upper side can be covered by an other uppermost layer, for example, one of the second prepreg layers 81b, and one prepreg layer of transverse fibers.

In the above embodiment, the high thermal conductivity sheet 81 is disposed on the outermost side in the radio transparent plate 27. This is advantageous in good efficiency in the heat dissipation, because the residual heat from the object H to the radio transparent plate 27 can be scattered at an outer surface with high effect of heat dissipation. The high thermal conductivity sheet 81 may not be positioned on the outermost side. Namely, one other layer may be formed and positioned outside the high thermal conductivity sheet 81, which should be positioned outside the low thermal conductivity sheet 82. Also, one other layer may be formed between the high and low thermal conductivity sheets 81 and 82. A layer may be formed on an inner side of the low thermal conductivity sheet 82.

In the above embodiment, the detection panel 35 is attached to the radio transparent plate 27 directly. However, an additional part can be used between the detection panel 35 and the radio transparent plate 27 to attach the detection panel 35 to the inner surface of the radio transparent plate 27. A method of the attachment of the detection panel 35 may be fastening with a screw, clamping or the like other than the adhesion. If there is no clearance space or a very small space between the detection panel 35 and the radio transparent plate 27 typically by use of the adhesion, residual heat of the radio transparent plate 27 is likely to conduct to the detection panel 35. The feature of the present invention is typically important. If the fastening with a screw or clamping is used for attachment, a clearance space is formed between the detection panel 35 and the radio transparent plate 27 in contrast with the adhesion for fastening. Residual heat of the radio transparent plate 27 can conduct through air to the detection panel 35 and also through contact portions of the radio transparent plate 27 and the detection panel 35. Effect of the invention can be obtained.

In the above embodiment, an example of touching the radio transparent plate 27 is according to a body part of the patient as object H. Note that the radio transparent plate 27 on the outer side is susceptible to various environmental factors of the place where the housing 26 is installed. However, the feature of the invention is effective in removing influence of local rise of the temperature of the radio transparent plate 27 even under a condition of environmental factors of the place.

In the above embodiment, the detection panel 35 has the detection surface 38 with the pixels 37. However, a resin sheet having transparency and X-ray transparency with a smaller thickness can be used instead of the glass substrate 71. Also, the scintillator 61 can be utilized as a substrate for forming the pixels 37 without the glass substrate 71, for use by way of a detection panel with the detection surface 38. The use of the resin sheet and the scintillator 61 as a substrate is effective in transmitting residual heat of the radio transparent plate 27 to the detection surface 38 sufficiently rapidly. Also, the housing can have a still smaller thickness according to flexibility in the detection panel or the housing having the transparent plate. The feature of the invention is specifically important.

Various materials may be used for forming the high and low thermal conductivity sheets 81 and 82 without using the pitch-based and PAN carbon materials. It is possible to use carbon material for only one of the high and low thermal conductivity sheets 81 and 82. However, the use of the carbon material is specifically preferable because of its good performance for the electronic cassette with the features of the lightweight property, high rigidity, and high X-ray transparency.

In the above embodiment, the detection surface has the standardized size 383.5×459.5 mm. However, the detection surface may have another size. In the above embodiment, the front cover of the housing is constituted by the radio transparent plate 27 and the cover frame 56a. However, a full surface of the front of the housing can be constituted by the radio transparent plate 27.

In the above embodiment, the radio transparent plate 27 is in the rectangular quadrilateral shape. However, the radio transparent plate 27 may be in a trapezoidal shape or the like which can be long in one direction.

In the above embodiment, the cover frame 56a of the housing 26 is formed from resin. The rear cover 57 is formed from stainless steel or other metal as a general-purpose material. In the drawing, the cover frame 56a and the rear cover 57 are hatched for expressing the opacity. However, the cover frame 56a and the rear cover 57 can be formed from radio transparent materials or radiopaque materials.

In the above embodiment, the radiation is X-rays. However, radiation according to the invention may be gamma rays or the like other than X-rays.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An electronic cassette for detecting radiation from an object to form an image thereof according to radiation imaging, comprising:
a radio transparent plate of a quadrilateral shape, including at least high and low thermal conductivity sheets superimposed on one another in a direction of entry of said radiation, and being so anisotropic that thermal conductivity is higher in a longitudinal direction of said quadrilateral shape than in a transverse direction of said quadrilateral shape;
a scintillator for converting said radiation passed through said radio transparent plate into light;
a detection panel for converting said light from said scintillator into an electric signal;
a housing for containing said scintillator and said detection panel, said housing having one receiving surface where said radio transparent plate is disposed.

2. An electronic cassette as defined in claim 1, wherein said high thermal conductivity sheet is disposed at an outer surface of said radio transparent plate.

3. An electronic cassette as defined in claim 2, wherein said high thermal conductivity sheet contains carbon material.

4. An electronic cassette as defined in claim 2, wherein said high thermal conductivity sheet includes:
at least one first prepreg layer, produced by impregnating matrix resin in carbon fibers, and disposed to align said carbon fibers in said longitudinal direction;
at least one second prepreg layer, produced by impregnating matrix resin in carbon fibers, and disposed to align said carbon fibers in said transverse direction.

5. An electronic cassette as defined in claim 4, wherein a layer number of said at least one first prepreg layer is higher than a layer number of said at least one second prepreg layer.

6. An electronic cassette as defined in claim 5, wherein said second prepreg layer is superimposed on said first prepreg layer in an alternate manner therewith.

7. An electronic cassette as defined in claim 5, wherein a plurality of said first prepreg layer include two or more layers superimposed on one another and disposed between two of said second prepreg layer.

8. An electronic cassette as defined in claim 1, wherein said detection panel is secured to said radio transparent plate.

9. An electronic cassette as defined in claim 8, wherein said detection panel is attached by adhesion.

10. An electronic cassette as defined in claim 1, wherein a condition
TL/TS=L/S
is satisfied, where TL is said thermal conductivity of said high thermal conductivity sheet in said longitudinal direction, TS is said thermal conductivity of said high thermal conductivity sheet in said transverse direction, L is a length of a longer side line of said quadrilateral shape, and S is a length of a shorter side line of said quadrilateral shape.

11. An electronic cassette as defined in claim 1, wherein said housing has a size according to international standard ISO 4090:2001.

12. An electronic cassette as defined in claim 1, further comprising an opening, formed in said receiving surface of said housing, and closed by said radio transparent plate secured thereto.
